(19) United States
(12) Patent Application Publication
(10) Pub. No.: US 2007/0236147 A1
(43) Pub. Date: Oct. 11, 2007

(54) GLASS FOR COVERING ELECTRODES, ELECTRIC WIRING-FORMED GLASS PLATE AND PLASMA DISPLAY DEVICE

(75) Inventor: Hitoshi ONODA, Koriyama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Asahi Glass Company, Limited, Chiyoda-ku (JP)

(21) Appl. No.: 11/696,321

(22) Filed: Apr. 4, 2007

(30) Foreign Application Priority Data
Apr. 6, 2006 (JP) 2006-105313

(51) Int. Cl. H01J 17/49; C03C 3/12; C03C 3/14

(52) U.S. Cl. 313/586; 313/583; 501/49; 501/41; 313/587

(57) ABSTRACT

Glass for covering electrodes which can minimize a warpage of e.g. a front substrate of a plasma display device.

Glass for covering electrodes, consisting essentially of, as represented by mol %, from 30 to 47% of B₂O₃, from 25 to 42% of SiO₂, from 5 to 17% of ZnO, and from 9 to 17% of Li₂O+Na₂O+K₂O, provided that K₂O and either one or both of Li₂O and Na₂O are contained, and Li₂O is from 0 to 2.5%, and that no PbO is contained. The glass for covering electrodes, wherein Na₂O/K₂O is less than 0.25, and Li₂O is from 0.1 to 2.5%. The glass for covering electrodes, wherein Na₂O/K₂O is from 0.25 to 1, and Li₂O is from 0 to 1.5%.

### BACKGROUND OF THE INVENTION

1. Field of the Invention

The present invention relates to glass for covering electrodes suitable for insulating covering of transparent electrodes made of e.g. ITO (indium oxide doped with tin) or tin oxide, in a case where the transparent electrodes are formed on glass substrates, an electric wiring-formed glass plate and a plasma display device (PDP).

2. Discussion of Background

PDP is a representative large-screen full-color display device.

PDP is produced in such a manner that a front substrate to be used as a display surface and a rear substrate having a plurality of stripe- or waffle-shaped barrier ribs formed thereon are sealed as faced with each other, and discharge gas is introduced between such substrates.

The front substrate is one in which a plurality of display electrode pairs for inducing surface discharge are formed on a front glass substrate, and the electrode pairs are covered by transparent glass.

The rear substrate is one in which address electrodes perpendicular to the above display electrode pairs are formed on a rear glass substrate, the address electrodes are covered by glass (usually colored glass), and barrier ribs and fluorescent layers are formed thereon.

Covering the electrodes by glass on the front substrate and the rear substrate is carried out by e.g. a method of transferring a green sheet containing a glass powder onto the electrodes, followed by firing, or applying a paste containing a glass powder on electrodes, followed by firing.

However, such firing is likely to cause warpage of the substrates, and in order to solve such a problem, it has been proposed to carry out cooling after firing by means of a special method (see Patent Document 1).

Patent Document 1: JP-A-2003-331724

### SUMMARY OF THE INVENTION

Conventional glass for covering electrodes is considered to be likely to warp as mentioned above, but it is considered that in the production of PDP, the problem of the warpage is solved by means of e.g. such a method as proposed in Patent Document 1.

However, it is expected that if it is possible to obtain glass for covering electrodes which is unlikely to warp, it is unnecessary to adopt such a special method in the production of PDP.

It is an object of the present invention to provide glass for covering electrodes, an electric wiring-formed glass plate and PDP, which can solve such a problem.

The present invention provides glass for covering electrodes (the glass of the present invention), consisting essentially of, as represented by mol % based on the following oxides, from 30 to 47% of B₂O₃, from 25 to 42% of SiO₂, from 5 to 17% of ZnO, and from 9 to 17% of Li₂O+Na₂O+K₂O, provided that K₂O and either one or both of Li₂O and Na₂O are contained, and when Li₂O is contained, a content of Li₂O is at most 2.5%, and that no PbO is contained.

Further, the present invention provides the glass of the present invention which is glass for covering electrodes (the first glass), wherein Na₂O/K₂O is less than 0.25, and Li₂O is from 0.1 to 2.5%.

Further, the present invention provides the glass of the present invention which is glass for covering electrodes (the second glass), wherein Na₂O/K₂O is from 0.25 to 1, and when Li₂O is contained, a content of Li₂O is at most 1.5%.

Further, the present invention provides the glass of the present invention which is glass for covering electrodes (the third glass), wherein Na₂O/K₂O exceeds 1, and no Li₂O is contained.

Further, the present invention provides the glass of the present invention which is glass for covering electrodes (the fourth glass), wherein Na₂O is from 4 to 8%, K₂O is from 5 to 10%, when MgO, CaO, SrO and/or BaO is contained, the total content thereof is at most 11%, when CuO, CeO₂ and/or CoO is contained, the total content thereof is at most 3%, and the total content of B₂O₃, SiO₂, ZnO, Li₂O, Na₂O, K₂O, MgO, CaO, SrO, BaO, CuO, CeO₂ and CoO is at least 90%.

Further, the present invention provides an electric wiring-formed glass plate comprising a glass plate and an electric wiring pattern formed thereon, wherein the electric wiring pattern is covered by the glass for covering electrodes.

Further, the present invention provides PDP comprising a front glass substrate to be used as a display surface, a rear glass substrate and barrier ribs to define cells, wherein the front glass substrate has transparent electrodes which are covered by the glass for covering electrodes.

The present inventor coated a substrate for PDP with non-lead glass having various compositions comprising from 30 to 47 mol % of B₂O₃, from 30 to 42 mol % of SiO₂, from 5 to 17 mol % of ZnO, and K₂O, followed by firing, and then measured the warpage of the substrate having a glass layer formed thereon by a method as described below. As a result, where the warpage is indicated as minus when the surface of the substrate having no glass layers formed becomes concave-shape, and the warpage is indicated as plus when the surface of the same substrate becomes convex-shape, he has found that one containing neither Li₂O nor Na₂O has a large warpage, and further, if the content of Li₂O is increased, the warpage tends to increase, and thus arrived at the present invention.

Further, he has found that with regard to glass containing no Li₂O, as the molar ratio of Na₂O to K₂O (Na₂O/K₂O) increases from 0 to 1, the warpage monotonously increases from a value of minus to a value of plus, and if Na₂O/K₂O exceeds 1, its increase rate becomes low, and thus arrived at the preferred embodiment of the present invention.

### DETAILED DESCRIPTION OF THE PREFERRED EMBODIMENTS

By coating electrodes of a front substrate for PDP using the glass of the present invention, it is possible to reduce warpage of the front substrate.

The glass of the present invention is usually used for covering electrodes after subjected to powderization. Here, the powderization is usually carried out by grinding the glass, followed by classifying.

In a case where the electrodes are covered by a glass paste, the powdered glass of the present invention (hereinafter referred to as “the glass powder of the present invention”) is kneaded with a vehicle to obtain a glass paste. The glass paste is applied on a glass substrate on which electrodes such as transparent electrodes are formed, and fired to form a glass layer covering the electrodes. In the production of a front substrate for PDP, the firing is conducted typically at a temperature of at most 600° C.

In a case where the electrodes are to be covered by a green sheet, the glass powder of the present invention is kneaded with a resin, and the kneaded product obtained is applied on a supporting film such as a polyethylene film to obtain a green sheet. This green sheet is transferred onto electrodes formed, for example, on a glass substrate, and fired to form a glass layer covering the electrodes.

A mass mean particle diameter (D₅₀) of the glass powder of the present invention is preferably at least 0.5 μm. If D₅₀ is less than 0.5 μm, it may take a too long time for powderization. D₅₀ is more preferably at least 0.7 μm. Further, the above average mass mean particle diameter is preferably at most 4 μm, more preferably at most 3 μm.

The maximum particle diameter of the glass powder of the present invention is preferably at most 20 μm. If the maximum particle diameter exceeds 20 μm, the surface of the glass layer becomes so uneven as to distort an image on the PDP in the use for formation of a glass layer for covering the electrodes of PDP, the thickness of which is required to be usually at most 30 μm. The maximum particle diameter is more preferably at most 10 μm.

The glass of the present invention preferably has an average linear expansion coefficient (a) of from 65×10⁻⁷ to 90×10⁻⁷/° C., typically from 65×10⁻⁷ to 85×10⁻⁷/° C. in a temperature range of from 50 to 350° C.

The glass of the present invention preferably has a softening point (Ts) of at most 630° C. If it exceeds 630° C., it may be difficult to obtain a precise fired layer (glass layer) by the firing at a temperature of at most 600° C. The softening point is more preferably at most 600° C.

The glass of the present invention is suitable when the relative permittivity (ε) at 1 MHz is to be made low, for example, when ε is to be made less than 8, and such ε is typically from 6 to 7.

The warpage (W) obtained by measuring the substrate on which the glass layer made of the glass of the present invention is formed, by means of a method as mentioned below, is preferably within a range of from −50 to 50 μm, more preferably from −30 to 30 μm. Hereinafter, the term “warpage” is used, in principle, in terms of its size (absolute value of W), irrespective of whether the warpage is a concave-shape or a convex-shape.

Now, the composition of the glass of the present invention will be described. Hereinafter, “mol %” is simply indicated by “%”.

B₂O₃ is a component to stabilize the glass or to lower Ts, and is essential. If B₂O₃ is less than 30%, vitrification tends to be difficult, and it is preferably at least 32%. If it exceeds 47%, Ts rather becomes high, or phase separation is likely to occur. B₂O₃ is preferably at most 45%, more preferably at most 42%, typically at most 40%.

SiO₂ is a component to form the matrix of the glass, and is essential. If SiO₂ is less than 25%, vitrification tends to be difficult, and it is preferably at least 30%, more preferably at least 32%. If SiO₂ exceeds 42%, Ts becomes too high, and SiO₂ is preferably at most 40%, more preferably at most 38%.

ZnO is a component to lower Ts or α, and is essential. If ZnO is less than 5%, Ts becomes high, and ZnO is preferably at least 10%. If it exceeds 17%, crystals are likely to precipitate during firing. ZnO is preferably at most 15%, and typically at most 12% when Ts is to be more lowered.

Li₂O, Na₂O and K₂O are components to facilitate vitrification or to lower Ts, and K₂O and either one or both of Li₂O and Na₂O must be contained.

If the total content R₂O of these three components is less than 9%, Ts becomes high. It is typically at least 10%. If R₂O exceeds 17%, a becomes high. It is typically at most 15%.

If neither Li₂O nor Na₂O is contained, or no K₂O is contained, the warpage becomes high.

When Li₂O is contained, the warpage becomes high when the content exceeds 2.5%.

The total content of Na₂O and K₂O is typically at least 10.5%.

The glass of the present invention consists essentially of the above components, but may contain other components within a range not impair the purpose of the present invention. In such a case, the total content of the components other than the above components is preferably at most 12%, more preferably at most 10%, typically at most 5%.

For example, in order to lower Ts or α, there is a case where MgO, CaO, SrO or BaO may be contained in such a range that the total content RO of these four components is at most 11%. If it exceeds 11%, vitrification tends to be difficult. RO is typically at most 7%.

Further, in a case where it is desired to suppress such a phenomenon that the glass is colored by carbon remaining in the glass after firing because of insufficient removal of the binder in the firing, CuO, CeO₂ or CoO may be contained in such an amount that the total content of these three components is up to 3%. If the above total content exceeds 3%, coloration of the glass rather becomes remarkable. It is typically at most 1.5%.

When any one of these three components is to be contained, it is typical to incorporate CuO in a range of at most 1.5%.

Further, for example, in order to improve the sintering properties, Bi₂O₃ may be contained in an amount of up to 5%. However, Bi₂O₃ has resource problems, etc., and from this point of view, no Bi₂O₃ is preferably contained.

In addition, components such as Al₂O₃, TiO₂, ZrO₂, SnO₂ and MnO₂ are exemplified. These components are added usually for the purpose of adjusting α, Ts, chemical durability, stability of the glass, transmittance of a glass covering layer or the like, or suppressing a yellow color by colloidal silver.

Further, the glass of the present invention contains no PbO.

The above first glass is one wherein Na₂O/K₂O is less than 0.25, and Li₂O is from 0.1 to 2.5%, so as to bring the absolute value of W to be, for example, at most 40 μm.

When Na₂O/K₂O is 0, namely, no Na₂O is contained, Li₂O is preferably from 1 to 2%, typically from 1.3 to 1.7. The same applies, when Na₂O/K₂O exceeds 0 and at most 0.04.

When Na₂O/K₂O exceeds 0.04 and at most 0.2, Li₂O is typically from 0.5 to 1.5%.

When Na₂O/K₂O exceeds 0.2 and less than 0.25, Li₂O is typically from 0.1 to 1.3%.

When Na₂O is contained, the content is typically at most 3.5%.

Further, the content of K₂O is typically from 9 to 14%.

The first glass is a preferred embodiment for e.g. improving the transparency of a glass layer by increasing the sintering property.

The above second glass is one wherein Na₂O/K₂O is from 0.25 to 1, and when Li₂O is contained, the content is made to be at most 1.5%, so as to bring the absolute value of W to be, for example, at most 40 μm.

When Na₂O/K₂O is at least 0.25 and less than 0.4, in order to bring the absolute value of W to be lower, Li₂O is preferably contained, and the content is typically from 0.1 to 1.3%.

When Na₂O/K₂O is at least 0.4 and at most 1, no Li₂O is preferably contained, and even when Li₂O is contained, it is preferably at most 0.5%.

The content of Na₂O is typically from 2 to 8%, and the content of K₂O is typically from 5 to 13%.

The second glass is a preferred embodiment in a case where it is desired to prevent so called a yellow color by colloidal silver at the time of firing, which is likely to occur in covering silver electrodes.

The above third glass is one wherein Na₂O/K₂O exceeds 1, and no Li₂O is contained, so as to bring the absolute value of W to be, for example, at most 50 μm. Further, Na₂O/K₂O is typically at most 2.

The content of Na₂O is typically from 5 to 10%.

The above fourth glass may contain a component other than respective components of B₂O₃, SiO₂, ZnO, Li₂O, Na₂O, K₂O, MgO, CaO, SrO, BaO, CuO, CeO₂ and CoO in an amount of at most 10% in total within a range not to impair the purpose of the present invention, and their total content is preferably at most 5% in total.

The fourth glass typically contains no Li₂O.

As mentioned above, the glass of the present invention is one which is suitable when ε is to be made low at a level of e.g. from 6 to 7, but in a case where such ε is not desired to be made so low, the following glass (glass A), namely, glass consisting essentially of, as represented by mol % based on the following oxide, from 33 to 42% of B₂O₃, from 5 to 12% of SiO₂, from 28 to 45% of ZnO, from 3 to 8% of Li₂O+Na₂O+K₂O, from 0 to 4% of Li₂O, from 5 to 20% of MgO+CaO+SrO+BaO, from 5 to 15% of BaO, and from 0 to 3% of CuO+CeO₂+CoO, provided that no PbO is contained, is a preferred embodiment, and such ε is typically from 8 to 9.

Now, the composition of glass A will be described.

B₂O₃ is a component to stabilize the glass or to lower Ts, and is essential. If it is less than 33%, vitrification tends to be difficult, or Ts tends to be high. It is typically at least 34%, and if it exceeds 42%, vitrification rather tends to be difficult. It is preferably at most 42%, typically at most 40%.

SiO₂ is a component to form the matrix of the glass, and is essential. If SiO₂ is less than 5%, vitrification tends to be difficult, and it is typically at least 7%. If it exceeds 12%, Ts tends to be too high. It is typically at most 11%.

ZnO is a component to lower Ts or α, and is essential. If it is less than 28%, Ts tends to be high. If it exceeds 45%, vitrification tends to be difficult, or crystals are likely to precipitate during firing, and it is preferably at most 42%. ZnO is typically from 30 to 40%.

Li₂O, Na₂O and K₂O are components having an effect to facilitate vitrification or to lower Ts, and at least one of them must be contained. If the total content R₂O of these three components is less than 3%, the above effect becomes low, and it is typically at least 4%. If R₂O exceeds 8%, α becomes high.

When Li₂O is contained, if the content exceeds 4%, the warpage tends to be high. It is typically at most 3%.

When Li₂O is contained, the content is typically at most 4%.

The content of K₂O is preferably at least 2%. If it is less than 2%, the warpage is likely to be high. In such a case, the content of K₂O is typically at most 6%.

BaO is a component to lower Ts, and is essential. If the content of BaO is less than 5%, Ts tends to be high. It is typically at least 6%, and if it exceeds 15%, a tends to be high. It is typically at most 13%.

When the warpage is to be made small, it is preferred that B₂O₃ is at most 38%, ZnO is at least 32%, and BaO is at most 11%.

None of MgO, CaO and SrO is essential, but in order to lower Ts or α, the total content RO of these three components and BaO may be up to 20%. If it exceeds 20%, vitrification tends to be difficult. RO is typically from 8 to 18%.

When CaO is contained, the content thereof is preferably at most 5%. If it exceeds 5%, crystals are likely to precipitate during firing.

None of CuO, CeO₂ and CoO is essential, but, for example, in order to suppress such a phenomenon that the glass is colored by carbon remaining in the glass after firing because of insufficient removal of the binder in the firing, at least one of them is preferably contained within a range where the total content of these three components is at most 3%. If the above total content exceeds 3%, coloration of the glass rather tends to be remarkable. It is typically at most 1.5%.

When any one of three components is to be contained, it is typical to incorporate CuO in a range of at most 1.5%, and a range of 0.3 to 1% is exemplified.

Glass A consists essentially of the above components, but may contain other components within a range not to impair the purpose of the present invention. In a case where such other components are contained, their total content is preferably at most 10%, typically at most 5%.

Such components may, for example, be Al₂O₃, TiO₂, ZrO₂, SnO₂ and MnO₂. Such components are added usually for the purpose of adjusting α, Ts, chemical durability, stability of the glass or transmittance of the glass covering layer, or suppressing a yellow color by colloidal silver.

Further, no PbO is contained.

Further, for example, in order to improve the sintering property, Bi₂O₃ may be contained in a range of at most 5%. However, Bi₂O₃ has resource problems, etc., and no Bi₂O₃ is more preferably contained.

The electric wiring-formed glass plate of the present invention is typically a PDP front substrate, and in such a case, the electric wiring is constituted by display electrode pairs.

In the electric wiring-formed glass plate of the present invention, the maximum diameter of a portion covered by the glass for covering electrodes is typically at least 14 cm, and for such construction, the effect of suppression of the warpage will be remarkable. Here, for example, when the above portion is rectangular, the above maximum diameter is meant for the longer diagonal line among its two diagonal lines, and the maximum diameter is at least 106 cm when used for PDP of at least 42 inch.

PDP of the present invention may be produced by well known methods except that the glass of the present invention is used as glass for covering electrodes.

### EXAMPLES

Starting materials were formulated and mixed so that the composition would be as shown by mol % in lines from B₂O₃ to CoO or CuO in Tables. Each mixture was heated to 1,250° C. and melted for 60 minutes by means of a platinum crucible.

Examples 1 to 9 represent Examples for the first glass of the present invention, Examples 10 to 36 represent Examples for the second glass of the present invention, Examples 37 to 40 represent Examples for the third glass of the present invention, Examples 41 to 48 represent Comparative Examples, Examples A1 to A6 represent Examples for glass A, and Example A7 represents Comparative Example for glass A. Further, in each of Examples 8, 9, 32 to 36, 39 and 40, melting as mentioned above was not carried out, and the values of Ts, α, ε and W were calculated from the composition.

The molten glass obtained as mentioned above was partly poured into a stainless-steel frame and gradually cooled. The glass gradually cooled was processed into a cylindrical shape with a length of 20 mm and a diameter of 5 mm to obtain a sample, and such a sample was subjected to measurement of the above a by means of a horizontal differential detection system thermal dilatometer TD5010SA-N manufactured by Bruker AXS K.K. The results are shown in Tables (unit: 10⁻⁷/° C.).

The remaining molten glass was partly poured into stainless-steel rollers to process into flakes. The glass flakes obtained were subjected to dry grinding for 16 hours by an alumina ball mill, followed by airflow classification, to prepare a glass powder having a D₅₀ of from 2 to 4 μm.

Using this glass powder as a sample, the above Ts was measured by means of a differential thermal analyzer (DTA). The results are shown in Tables (unit: ° C.).

The rest of the above molten glass was poured into a stainless-steel frame and gradually cooled. The glass gradually cooled was processed into a disk shape with a diameter of 40 mm and a thickness of 3 mm, and electrodes were formed on both sides thereof by vapor deposition of aluminum to obtain a sample. The above ε was measured by an electrode-contact method by means of LCR meter 4192A manufactured by Yokokawa Hewlett-Packard Company. The results are shown in Tables.

Furthermore, 100 g of the above glass powder was kneaded with 25 g of an organic vehicle having 10 mass % of ethyl cellulose dissolved in α-terpineol or the like, to prepare a paste ink (glass paste). The paste ink was uniformly screen-printed on a glass substrate (PD200 manufactured by Asahi Glass Company, Limited) having a size of 100 mm×100 mm (maximum diameter: 141 mm) and a thickness of 1.8 mm, so that the thickness after the firing would be 20 μm, and dried at 120° C. for 10 minutes. Then, such a glass substrate was heated at a temperature- raising rate of 10° C. per minute up to 570° C., and maintained at the temperature for 30 minutes to carry out firing, whereby a glass layer was formed on the glass substrate.

Along a portion having a length of 100 mm on a diagonal line of the glass substrate provided with the glass layer, the warpage was measured by means of a surface roughness meter. The results are shown in Tables (unit: μm). Such a warpage (W) is preferably within a range of ±50 μm. Further, the values of W in Examples 28 to 31 and 38 are estimated values calculated from the composition.

TABLE 1

| | Ex. | | | | | | | |
|---|---|---|---|---|---|---|---|---|
| | 1 | 2 | 3 | 4 | 5 | 6 | 7 | 8 |
| B₂O₃ | 35 | 35 | 32.5 | 35 | 35 | 35 | 35 | 45 |
| SiO₂ | 40 | 39 | 35 | 35 | 35 | 35 | 35 | 30 |
| ZnO | 13 | 13 | 15 | 15 | 15 | 15 | 15 | 9 |
| Li₂O | 0.5 | 0.5 | 1 | 1 | 1 | 1.5 | 1 | 2.5 |
| Na₂O | 1.5 | 1.5 | 0 | 1 | 1 | 0 | 2 | 0 |
| K₂O | 10 | 11 | 11.5 | 11.5 | 11.5 | 12 | 10.5 | 8.5 |
| MgO | 0 | 0 | 5 | 1.5 | 0 | 0 | 0 | 5 |
| CaO | 0 | 0 | 0 | 0 | 0 | 0 | 0 | 0 |
| SrO | 0 | 0 | 0 | 0 | 0 | 0 | 0 | 0 |
| BaO | 0 | 0 | 0 | 0 | 1.5 | 1.5 | 1.5 | 0 |
| Al₂O₃ | 0 | 0 | 0 | 0 | 0 | 0 | 0 | 0 |
| CuO | 0 | 0 | 0 | 0 | 0 | 0 | 0 | 0 |
| CeO₂ | 0 | 0 | 0 | 0 | 0 | 0 | 0 | 0 |
| CoO | 0 | 0 | 0 | 0 | 0 | 0 | 0 | 0 |
| Na₂O/ | 0.15 | 0.14 | 0 | 0.09 | 0.09 | 0 | 0.19 | 0 |
| K₂O | | | | | | | | |
| Ts | 613 | 609 | 618 | 604 | 602 | 604 | 599 | 618 |
| α | 81 | 85 | 84 | 88 | 86 | 88 | 91 | 75 |
| ε | 6.4 | 6.6 | 6.9 | 6.8 | 7.0 | 7.0 | 7.0 | 6.8 |
| W | −15.9 | −22.2 | −30.9 | −5.5 | −10.5 | −3.5 | 0.4 | 18.2 |

TABLE 2

| | Ex. | | | | | | | |
|---|---|---|---|---|---|---|---|---|
| | 9 | 10 | 11 | 12 | 13 | 14 | 15 | 16 |
| B₂O₃ | 40 | 39.5 | 39.5 | 40 | 35 | 35 | 35 | 35 |
| SiO₂ | 27 | 35.5 | 35.5 | 37.5 | 37.5 | 40 | 40 | 40 |
| ZnO | 6 | 10.5 | 10.5 | 10.5 | 10.5 | 13 | 13 | 13 |
| Li₂O | 1 | 0 | 0 | 0 | 0 | 0 | 0 | 0 |
| Na₂O | 2 | 6 | 3 | 3 | 3 | 3 | 6 | 4 |
| K₂O | 10 | 7.5 | 10.5 | 9 | 9 | 9 | 6 | 8 |
| MgO | 5 | 0 | 0 | 0 | 5 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 4 | 0 | 0 | 0 | 0 | 0 | 0 | 0 |
| Al₂O₃ | 5 | 0 | 0 | 0 | 0 | 0 | 0 | 0 |
| CuO | 0 | 1 | 1 | 0 | 0 | 0 | 0 | 0 |
| CeO₂ | 0 | 0 | 0 | 0 | 0 | 0 | 0 | 0 |
| CoO | 0 | 0 | 0 | 0 | 0 | 0 | 0 | 0 |
| Na₂O/ | 0.20 | 0.80 | 0.29 | 0.33 | 0.33 | 0.33 | 1.00 | 0.50 |
| K₂O | | | | | | | | |
| Ts | 600 | 593 | 596 | 605 | 624 | 617 | 609 | 614 |
| α | 87 | 87 | 85 | 86 | 80 | 83 | 79 | 82 |
| ε | 6.7 | 6.3 | 6.2 | 6.4 | 6.6 | 6.6 | 6.5 | 6.5 |
| W | −5.6 | 9.5 | −21.8 | −19.9 | −27.1 | −18.7 | 29.7 | −8.4 |

TABLE 3

| | Ex. | | | | | | | |
|---|---|---|---|---|---|---|---|---|
| | 17 | 18 | 19 | 20 | 21 | 22 | 23 | 24 |
| B₂O₃ | 35 | 35 | 32.5 | 40 | 35 | 35 | 35 | 35 |
| SiO₂ | 39 | 40 | 35 | 36 | 41 | 36 | 38.5 | 36 |
| ZnO | 13 | 13 | 15 | 11 | 11 | 16 | 13.5 | 11 |
| Li₂O | 0 | 0 | 0 | 0 | 0 | 0 | 0 | 0 |
| Na₂O | 4 | 4.5 | 5 | 4.5 | 4.5 | 4.5 | 4.5 | 4.5 |
| K₂O | 9 | 7.5 | 7.5 | 8.5 | 8.5 | 8.5 | 8.5 | 8.5 |
| MgO | 0 | 0 | 5 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 0 | 0 | 0 | 0 | 0 | 0 | 0 | 0 |
| Al₂O₃ | 0 | 0 | 0 | 0 | 0 | 0 | 0 | 5 |
| CuO | 0 | 0 | 0 | 0 | 0 | 0 | 0 | 0 |
| CeO₂ | 0 | 0 | 0 | 0 | 0 | 0 | 0 | 0 |
| CoO | 0 | 0 | 0 | 0 | 0 | 0 | 0 | 0 |
| Na₂O/ | 0.44 | 0.60 | 0.67 | 0.53 | 0.53 | 0.53 | 0.53 | 0.53 |
| K₂O | | | | | | | | |
| Ts | 610 | 610 | 616 | 598 | 609 | 603 | 611 | 604 |
| α | 86 | 85 | 86 | 85 | 87 | 85 | 86 | 86 |
| ε | 6.4 | 6.4 | 6.9 | 6.5 | 6.4 | 6.7 | 6.6 | 6.4 |
| W | −15.3 | −5.5 | −5.6 | 5.5 | 1.0 | 1.3 | −8.3 | −2.8 |

TABLE 4

| | Ex. | | | | | | | |
|---|---|---|---|---|---|---|---|---|
| | 25 | 26 | 27 | 28 | 29 | 30 | 31 | 32 |
| B₂O₃ | 32.5 | 32.5 | 32.5 | 40.9 | 44.7 | 44.7 | 29.7 | 32.5 |
| SiO₂ | 37 | 37 | 37 | 30.8 | 25.7 | 25.7 | 36.3 | 37 |
| ZnO | 15 | 15 | 15 | 14.9 | 14.9 | 14.9 | 14.9 | 15 |
| Li₂O | 0 | 0 | 0 | 0 | 0 | 0 | 0 | 1 |
| Na₂O | 4.5 | 5.5 | 6 | 5 | 4.8 | 4.8 | 6.1 | 2.5 |
| K₂O | 8.5 | 7.5 | 7 | 7.4 | 6.9 | 6.9 | 7.5 | 10 |
| MgO | 0 | 0 | 0 | 0 | 0 | 0 | 0 | 0 |
| CaO | 0 | 0 | 0 | 0.4 | 2.5 | 0 | 0 | 0 |
| SrO | 0 | 0 | 0 | 0 | 0 | 2.5 | 0 | 0 |
| BaO | 0 | 0 | 0 | 0 | 0 | 0 | 5 | 0 |
| Al₂O₃ | 2.5 | 2.5 | 2.5 | 0 | 0 | 0 | 0 | 2 |
| CuO | 0 | 0 | 0 | 0 | 0 | 0 | 0 | 0 |
| CeO₂ | 0 | 0 | 0 | 0.5 | 0.5 | 0.5 | 0.5 | 0 |
| CoO | 0 | 0 | 0 | 0.1 | 0.1 | 0.1 | 0.1 | 0 |
| Na₂O/ | 0.53 | 0.73 | 0.86 | 0.68 | 0.70 | 0.70 | 0.81 | 0.25 |
| K₂O | | | | | | | | |
| Ts | 605 | 600 | 605 | 598 | 598 | 600 | 603 | 599 |
| α | 86 | 84 | 84 | 84 | 83 | 84 | 96 | 86 |
| ε | 6.9 | 6.9 | 6.8 | 6.6 | 6.6 | 6.5 | 7.5 | 6.8 |
| W | −13.4 | 2.9 | 11.5 | 4 | 3 | 4 | 7 | −3 |

TABLE 5

| | Ex. | | | | | | | |
|---|---|---|---|---|---|---|---|---|
| | 33 | 34 | 35 | 36 | 37 | 38 | 39 | 40 |
| B₂O₃ | 32.5 | 32.5 | 40 | 43 | 39.5 | 32.3 | 45 | 45 |
| SiO₂ | 37 | 37 | 26 | 37 | 35.5 | 38.8 | 27 | 30 |
| ZnO | 15 | 15 | 10 | 6 | 10.5 | 14.9 | 7 | 6 |
| Li₂O | 1 | 1 | 1 | 0 | 0 | 0 | 0 | 0 |
| Na₂O | 3 | 4 | 3 | 7 | 9 | 7.5 | 7 | 9 |
| K₂O | 8.5 | 9 | 10 | 7.5 | 4.5 | 6 | 6 | 5 |
| MgO | 0 | 0 | 5 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 0 | 0 | 0 | 0 | 0 | 0 | 4 | 0 |
| Al₂O₃ | 3 | 1.5 | 5 | 0 | 0 | 0 | 4 | 5 |
| CuO | 0 | 0 | 0 | 0 | 1 | 0 | 0 | 0 |
| CeO₂ | 0 | 0 | 0 | 0 | 0 | 0.5 | 0 | 0 |
| CoO | 0 | 0 | 0 | 0 | 0 | 0.1 | 0 | 0 |
| Na₂O/ | 0.35 | 0.44 | 0.30 | 0.93 | 2.00 | 1.25 | 1.17 | 1.80 |
| K₂O | | | | | | | | |
| Ts | 605 | 597 | 618 | 604 | 595 | 600 | 610 | 601 |
| α | 82 | 87 | 89 | 90 | 85 | 87 | 90 | 86 |
| ε | 6.7 | 6.8 | 7.0 | 6.4 | 6.3 | 6.8 | 6.7 | 6.3 |
| W | 6 | 10 | 0.5 | 14.1 | 45.8 | 42 | 21.2 | 34.5 |

TABLE 6

| | Ex. | | | | | | | |
|---|---|---|---|---|---|---|---|---|
| | 41 | 42 | 43 | 44 | 45 | 46 | 47 | 48 |
| B₂O₃ | 40 | 40 | 32.5 | 40 | 40 | 40 | 40 | 40 |
| SiO₂ | 36 | 36 | 35 | 36 | 36 | 36 | 35 | 39 |
| ZnO | 11 | 11 | 7.5 | 10.5 | 10.5 | 10.5 | 11.5 | 7.5 |
| Li₂O | 4.5 | 0 | 7.5 | 9 | 6 | 3 | 3 | 3 |
| Na₂O | 0 | 0 | 0 | 0 | 0 | 0 | 0 | 0 |
| K₂O | 8.5 | 13 | 7.5 | 4.5 | 7.5 | 10.5 | 10.5 | 10.5 |
| MgO | 0 | 0 | 10 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 0 | 0 | 0 | 0 | 0 | 0 | 0 | 0 |
| Al₂O₃ | 0 | 0 | 0 | 0 | 0 | 0 | 0 | 0 |
| CuO | 0 | 0 | 0 | 1 | 1 | 1 | 0 | 0 |
| CeO₂ | 0 | 0 | 0.5 | 0 | 0 | 0 | 0 | 0 |
| CoO | 0 | 0 | 0.1 | 0 | 0 | 0 | 0 | 0 |
| Na₂O/ | 0 | 0 | 0 | 0 | 0 | 0 | 0 | 0 |
| K₂O | | | | | | | | |
| Ts | 588 | 611 | 605 | 592 | 585 | 588 | 595 | 596 |
| α | 77 | 86 | 81 | 69 | 74 | 79 | 81 | 82 |
| ε | 6.4 | 6.6 | 6.9 | 6.3 | 6.5 | 6.5 | 6.2 | 6.4 |
| W | 78.7 | −87.0 | 89.9 | 87.8 | 79.0 | 66.2 | 55.9 | 66.1 |

TABLE 7

| | Ex. | | | | | | |
|---|---|---|---|---|---|---|---|
| | A1 | A2 | A3 | A4 | A5 | A6 | A7 |
| B₂O₃ | 39.5 | 35 | 35 | 35 | 35 | 34.5 | 39.5 |
| SiO₂ | 10 | 10 | 10 | 10 | 8 | 10 | 10 |
| ZnO | 30 | 39.5 | 39.5 | 39.5 | 39.5 | 40 | 30 |
| Li₂O | 2.5 | 2.5 | 0 | 0 | 0 | 0 | 5 |
| Na₂O | 0 | 0 | 2.5 | 0 | 3.5 | 2.5 | 0 |
| K₂O | 2.5 | 2.5 | 2.5 | 5 | 3.5 | 2.5 | 0 |
| CaO | 2.5 | 2.5 | 2.5 | 2.5 | 2.5 | 0 | 2.5 |
| BaO | 12.5 | 7.5 | 7.5 | 7.5 | 7.5 | 10 | 12.5 |
| CuO | 0.5 | 0.5 | 0.5 | 0.5 | 0.5 | 0.5 | 0.5 |
| Ts | 597 | 589 | 595 | 599 | 582 | 600 | 591 |
| α | 79 | 72 | 75 | 76 | 82 | 75 | 74 |
| ε | 8.4 | 8.4 | 8.5 | 8.5 | 8.5 | 8.6 | 8.4 |
| W | 24.5 | 12.5 | −12.8 | −12.7 | −15.4 | 3.2 | 34.1 |

The glass of the present invention can be used as glass for covering transparent electrodes of PDP, etc.

The entire disclosure of Japanese Patent Application No. 2006-105313 filed on Apr. 6, 2006 including specification, claims and summary are incorporated herein by reference in its entirety.

What is claimed is:

1. Glass for covering electrodes, consisting essentially of, as represented by mol % based on the following oxides, from 30 to 47% of B₂O₃, from 25 to 42% of SiO₂, from 5 to 17% of ZnO, and from 9 to 17% of Li₂O+Na₂O+K₂O, provided that K₂O and either one or both of Li₂O and Na₂O are contained, and when Li₂O is contained, the content of Li₂O is at most 2.5%, and provided that no PbO is contained.

2. The glass for covering electrodes according to claim 1, wherein Na₂O/K₂O is less than 0.25, and Li₂O is from 0.1 to 2.5%.

3. The glass for covering electrodes according to claim 2, wherein K₂O is from 9 to 14%.

4. The glass for covering electrodes according to claim 2, wherein Na₂O is from 0 to 3.5%.

5. The glass for covering electrodes according to claim 1, wherein no Na₂O is contained, and Li₂O is from 1 to 2%.

6. The glass for covering electrodes according to claim 1, wherein Na₂O/K₂O is from 0.25 to 1, and when Li₂O is contained, the content of Li₂O is at most 1.5%.

7. The glass for covering electrodes according to claim 6, wherein K₂O is from 5 to 13%.

8. The glass for covering electrodes according to claim 6, wherein Na₂O is from 2 to 8%.

9. The glass for covering electrodes according to claim 6, wherein Na₂O/K₂O is at least 0.4, and no Li₂O is contained.

10. The glass for covering electrodes according to claim 1, wherein Na₂O/K₂O exceeds 1, and no Li₂O is contained.

11. The glass for covering electrodes according to claim 10, wherein Na₂O is from 5 to 10%.

12. The glass for covering electrodes according to claim 10, wherein Na₂O/K₂O is at most 2.

13. The glass for covering electrodes according to claim 1, wherein Na₂O is from 4 to 8%, K₂O is from 5 to 10%, when MgO, CaO, SrO and/or BaO is contained, the total content thereof is at most 11%, when CuO, CeO₂ and/or CoO is contained, the total content thereof is at most 3%, and the total content of B₂O₃, SiO₂, ZnO, Li₂O, Na₂O, K₂O, MgO, CaO, SrO, BaO, CuO, CeO₂ and CoO is at least 90%.

14. The glass for covering electrodes according to claim 13, wherein no Li₂O is contained.

15. The glass for covering electrodes according to claim 1, wherein Na₂O+K₂O is at least 10.5%.

16. The glass for covering electrodes according to claim 1, wherein no Bi₂O₃ is contained.

17. The glass for covering electrodes according to claim 1, which has an average linear expansion coefficient of from 65×10⁻⁷ to 90×10⁻⁷/° C. within a temperature range of from 50 to 350° C.

18. The glass for covering electrodes according to claim 1, which has a softening point of at most 630° C.

19. An electric wiring-formed glass plate comprising a glass plate and an electric wiring pattern formed thereon, wherein the electric wiring pattern is covered by the glass for covering electrodes as defined in claim 1.

20. A plasma display device comprising a front glass substrate to be used as a display surface, a rear glass substrate and barrier ribs to define cells, wherein the front glass substrate has transparent electrodes which are covered by the glass for covering electrodes as defined in claim 1.
